(19) United States
(12) Patent Application Publication
(10) Pub. No.: US 2016/0112340 A1
(43) Pub. Date: Apr. 21, 2016

(54) METHOD AND SYSTEM FOR RESOURCE SHARING

(71) Applicant: TENCENT TECHNOLOGY (SHENZHEN) COMPANY LIMITED, Shenzhen (CN)

(72) Inventors: Xiangping ZHONG, Shenzhen (CN); Xuedan ZHONG, Shenzhen (CN); Xuechao LI, Shenzhen (CN); Yuewei FAN, Shenzhen (CN); Liangliang GUAN, Shenzhen (CN); Xuemin MA, Shenzhen (CN); Zifeng SHANG, Shenzhen (CN); Yisha LU, Shenzhen (CN)

(73) Assignee: TENCENT TECHNOLOGY (SHENZHEN) COMPANY LIMITED

(21) Appl. No.: 14/979,852

(22) Filed: Dec. 28, 2015

Related U.S. Application Data
(63) Continuation of application No. PCT/CN2014/079832, filed on Jun. 13, 2014.

(30) Foreign Application Priority Data
Jun. 24, 2013 (CN) 2013-10253771.7

(51) Int. Cl. H04L 12/911; H04L 29/08

(52) U.S. Cl. CPC H04L 47/70; H04L 67/1095; H04L 67/2842

(57) ABSTRACT

A resource sharing method is provided. The method includes obtaining a user identifier that logs in a current device through a resource sharing operation. The method also includes extracting corresponding binding device information from a server based on the user identifier and displaying the binding device information. Further, the method includes obtaining a device identifier selected from the displayed binding device information and sending the selected device identifier and resource to be shared with a device corresponding to the selected device identifier to the server, such that the server delivers the resource to be shared to the corresponding device based on the selected device identifier.

### CROSS-REFERENCES TO RELATED APPLICATIONS

This application is a continuation application of PCT Patent Application No. PCT/CN2014/079832, filed on Jun. 13, 2014, which claims priority of Chinese Patent Application No. 201310253771.7, filed on Jun. 24, 2013, the entire contents of which are incorporated by reference herein.

### FIELD OF THE INVENTION

The present invention generally relates to the field of Internet technology and, more particularly, to methods and systems for resource sharing.

### BACKGROUND

Users often store resources that are stored in a device in networks through the Internet. Further, the resources stored in the networks can be shared with multiple devices. For example, a bookmark stored locally is uploaded to a server through a browser running in a personal computer (PC) to store the bookmark in a network, such that a user can synchronize the bookmark stored in the network to a mobile device through the server to share the bookmark with multiple devices.

However, this resource sharing method requires that the resources to be shared are stored in the server. After the server shares the resources with other devices, the resources are still stored in the server, consuming very large storage space. In most cases, the users can only manually delete the shared resources stored in the server. Especially in practical applications, the users only focus on resource sharing. The users do not access the shared resources stored in the server again. Thus, a large amount of shared resources are stored in the server, greatly wasting the storage space of the server and causing very high storage cost.

### BRIEF SUMMARY OF THE DISCLOSURE

One aspect of the present disclosure includes a resource sharing method. The method includes obtaining a user identifier that logs in a current device through a resource sharing operation. The method also includes extracting corresponding binding device information from a server based on the user identifier and displaying the binding device information. Further, the method includes obtaining a device identifier selected from the displayed binding device information and sending the selected device identifier and resource to be shared with a device corresponding to the selected device identifier to the server, such that the server delivers the resource to be shared to the corresponding device based on the selected device identifier.

Another aspect of the present disclosure includes a resource sharing system. The system includes a user identifier obtaining module configured to obtain a user identifier that logs in a current device through a resource sharing operation. The system also includes a binding device information extracting module configured to extract corresponding binding device information from a server and display the binding device information based on the user identifier. Further, the system includes a sending processing module configured to obtain a device identifier selected from the displayed binding device information, and send the selected device identifier and resource to be shared to the server; where the resource to be shared is delivered to a corresponding device by the server based on the selected device identifier.

Another aspect of the present disclosure includes a resource sharing system comprising a device and a server which communicates with the device. The device includes a request initiating module configured to obtain a user identifier that logs in a current device through a resource sharing operation, and initiate a binding device obtaining request to the server based on the user identifier. The device also includes a display module configured to receive and display the returned binding device information. Further, the device includes a sending processing module configured to obtain the device identifier selected from the displayed binding device information, and send the selected device identifier and the resource to be shared to the server. In addition, the server includes a request responding module configured to extract the binding device information corresponding to the binding device obtaining request, and return the binding device information to the current device and a deliver processing module configured to receive the device identifier and the resource sent from the device, and deliver the resource to the corresponding device based on the device identifier.

Other aspects of the present disclosure can be understood by those skilled in the art in light of the description, the claims, and the drawings of the present disclosure.

### BRIEF DESCRIPTION OF THE DRAWINGS

In order to describe the technical solution of the embodiments of the present invention more clearly, drawings used in the description of the embodiments are introduced below. The drawings described below are merely some exemplary embodiments of the present invention. For those skilled in the art, on the premise of no inventive effort being involved, other drawings may also be obtained according to these drawings and the descriptions included herein.

FIG. 1 illustrates a flow chart of an exemplary process for resource sharing consistent with the disclosed embodiments;

FIG. 2 illustrates a flow chart of an exemplary process for extracting corresponding binding device information from a server based on a user identifier and displaying the binding device information consistent with the disclosed embodiments;

FIG. 3 illustrates a flow chart of an exemplary process for obtaining the device identifier selected from the displayed binding device information and sending the selected device identifier and resource to be shared to a server consistent with the disclosed embodiments;

FIG. 4 illustrates a flow chart of another exemplary process for resource sharing consistent with the disclosed embodiments;

FIG. 5 illustrates a schematic application diagram of an exemplary process for resource sharing consistent with the disclosed embodiments;

FIG. 6 illustrates a schematic diagram of an exemplary display interface of a current client consistent with the disclosed embodiments;

FIG. 7 illustrates a flow chart of an exemplary process for resource sharing consistent with the disclosed embodiments;

FIG. 8 illustrates a flow chart of an exemplary process for obtaining a device identifier contained in the displayed binding device information and sending the selected device identifier and resource to be shared to a server consistent with the disclosed embodiments;

FIG. 9 illustrates a flow chart of an exemplary process for receiving the device identifier and resource to be shared by a server, and sending the resource to be shared to a corresponding device based on the device identifier as shown in FIG. 7 consistent with the disclosed embodiments;

FIG. 10 illustrates a flow chart of an exemplary process for sending resource to a device corresponding to a device identifier as shown in FIG. 9 consistent with the disclosed embodiments;

FIG. 11 illustrates a flow chart of another exemplary process for resource sharing consistent with the disclosed embodiments;

FIG. 12 illustrates a flow chart of another exemplary process for resource sharing consistent with the disclosed embodiments;

FIG. 13 illustrates a schematic structure diagram of an exemplary system for resource sharing consistent with the disclosed embodiments;

FIG. 14 illustrates a schematic structure diagram of an exemplary binding device information extracting module consistent with the disclosed embodiments;

FIG. 15 illustrates a schematic structure diagram of an exemplary sending processing module consistent with the disclosed embodiments;

FIG. 16 illustrates a schematic structure diagram of another exemplary system for resource sharing consistent with the disclosed embodiments;

FIG. 17 illustrates a schematic structure diagram of another exemplary system for resource sharing consistent with the disclosed embodiments;

FIG. 18 illustrates a schematic structure diagram of an exemplary sending processing module shown in FIG. 17 consistent with the disclosed embodiments;

FIG. 19 illustrates a schematic structure diagram of an exemplary deliver processing module shown in FIG. 17 consistent with the disclosed embodiments;

FIG. 20 illustrates a schematic structure diagram of an exemplary deliver unit shown in FIG. 19 consistent with the disclosed embodiments;

FIG. 21 illustrates a schematic structure diagram of another exemplary device for resource sharing consistent with the disclosed embodiments;

FIG. 22 illustrates a schematic structure diagram of an exemplary device for resource sharing consistent with the disclosed embodiments; and

FIG. 23 shows an environment incorporating certain aspects of the present invention.

### DETAILED DESCRIPTION

In the following description, for purposes of illustration, many specific details are illustrated in order to provide a full understanding of one or more embodiments. However, obviously, those embodiments can also be implemented in the case of these specific details changed, replaced, or alternated. The followings, together with accompanying drawings, describe in detail certain embodiments of the present invention.

As used herein, the term web browser (commonly referred to as a browser) in this disclosure is a software application for retrieving, presenting and traversing information resources on the World Wide Web.

The term uniform resource locator (URL), also known as a webpage address, is an identification method used for completely describing addresses of webpages and other resources in the Internet. In the context of the World Wide Web, a bookmark includes a URL that is stored for later retrieval in any of various storage formats.

The term user identifier (UID) in this disclosure is a current user identification status (e.g., a qq account that a user logs in) in a browser.

The term globally unique identifier (GUID) in this disclosure is a unique number with a specific length (e.g., 128-bit) that is produced by algorithms to identify a particular component, application, file, database entry, and/or user.

The term Hypertext Transfer Protocol (HTTP) in this disclosure is an application protocol to exchange or transfer hypertext on the World Wide Web.

The term Transmission Control Protocol (TCP) in this disclosure is one of the core protocols of the Internet protocol suite (IP) resided at the transport layer. TCP provides reliable, ordered and error-checked delivery of a stream of octets between programs running on computers connected to a local area network, intranet or the public Internet.

The term push notification in this disclosure refers to an indication that can automatically deliver the messages to a user when a browser receives push messages from backend servers. The term push system in this disclosure refers to an overall end-to-end software system for implementing a push notification function that allows backend servers to delivery push messages to users.

FIG. 23 shows an environment incorporating certain aspects of the present invention. As shown in FIG. 23, environment 2300 may include a terminal device 2304, a server 2306, and the Internet 2302. The terminal device (also known as the terminal) 2304 may access the server 2306 through the Internet 2302 for certain personalized services provided by the server 2306. Although only one server 2306 and one terminal device 2304 are shown in the environment 2300, any number of terminal devices 2304 or servers 2306 may be included, and other devices may also be included.

The Internet 2302 may include any appropriate type of communication network for providing network connections to the terminal device 2304 and the server 2306 or among multiple terminal devices 2304 and servers 2306. For example, Internet 2302 may include the Internet or other types of computer networks or telecommunication networks, either wired or wireless.

A terminal device, as used herein, may refer to any appropriate user terminal with certain computing capabilities, such as a personal computer (PC), a work station computer, a server computer, a hand-held computing device (tablet), a smartphone or mobile phone, or any other user-side computing device. In certain embodiments, terminal device 2304 may be a mobile terminal device, such as a smartphone, a tablet computer, or a mobile phone, etc. Terminal device 2304 may be implemented on any appropriate computing platform.

A server, as used herein, may refer to one or more server computers configured to provide certain web server functionalities for sharing resource. A server may also include one or more processors to execute computer programs in parallel. The server may store webpages to be access by terminal devices, and each of these webpages has a unique web address. The unique web address is also called Uniform Resource Locator (URL). For example, a user needs to enter a URL to browse a webpage to be displayed on the terminal device using the HTTP.

A resource sharing process may be applied in Personal Computers (PCs), laptops, smartphones, Tablet PCs, wearable smart devices, Personal Digital Assistants (PDAs) and so on. Specifically, using mobile phone 2200 as an example. FIG. 22 illustrates a structure schematic diagram of an exemplary mobile phone consistent with the disclosed embodiments. As shown in FIG. 22, the mobile phone 2200 may include a Radio Frequency (RF) circuit 2210, a memory 2220, an input unit 2230, a display unit 2240, a sensor 2250, an audio circuit 2260, a wireless fidelity (Wi-Fi) module 2270, a processor 2280 containing at least one processor core, and a power source 2290. A person skilled in the art may understand that the structure of the mobile phone does not limit the mobile phone, and more or fewer components than those shown may be included, or some components may be combined, or different component arrangement may be included.

The RF circuit 2210 may be configured to receive and send electromagnetic waves and implement interconversion of electromagnetic waves and electrical signals, thus communicating with communication networks and other devices. The RF circuit 2210 may include, but is not limited to, an antenna, at least an amplifier, a digital signal processor (DSP), a RF transceiver, a coupler, a Low Noise Amplifier (LNA), a duplexer, a subscriber identity module (SIM), and a memory. In addition, the RF circuit 2210 may further communicate with various types of computer networks (e.g., Internet, Intranet, wireless network) or via wireless networks and other devices. The wireless networks may use any communication standard or protocol, which includes, but is not limited to, Global System of Mobile communication (GSM), Enhanced Data GSM Environment (EDGE), General Packet Radio Service (GPRS), Code Division Multiple Access (CDMA), Wideband Code Division Multiple Access CDMA (WCDMA), Long Term Evolution (LTE), Time Division Multiple Access (TDMA), Wireless Fidelity (Wi-Fi, e.g., IEEE 802.11a, IEEE 802.11b, IEEE 802.11g and/or IEEE 802.11n), Voice over Internet Protocol (VoIP), Worldwide Interoperability for Microwave Access (Wi-Max), and other protocols that can be used for Email, Instant Messaging (IM) and Short Messaging Service (SMS).

The memory 2220 may be configured to store software programs and modules (e.g., program instructions and modules corresponding to the webpage browsing method and apparatus on the mobile terminal). The processor 2280 executes all functional applications and data processing of the mobile phone by running the software programs and the modules that are stored in the memory 2220.

The memory 2220 may mainly include a program storage area and a data storage area. The program storage area may store an operating system, an application program required for at least one function (for example, a source sharing function), and so on. The data storage area may store data (for example, audio data) created according to use of the mobile phone. In addition, the memory 2220 may include a high speed random access memory (RAM), and may further include a nonvolatile memory, for example, at least one disk storage device, at least one flash storage device, or other volatile solid state storage devices.

The input unit 2230 may be configured to receive input number or character information and generate signal inputs related to user settings and function control of the mobile phone 2200. Specifically, the input unit 2230 may include a touch control panel 2231 and another input device 2232. The touch control panel 2231 is also known as a touchscreen, may collect touch operations of a user on or near the touch control panel 2231 (for example, a user operation on the touch control panel 2231 or near the touch control panel 2231 with any suitable object or accessory such as a finger and a stylus) and drive a corresponding connecting apparatus according to a preset program.

Optionally, the touch control panel 2231 may include two parts, a touch detecting apparatus and a touch controller. The touch detecting apparatus detects a position of a user's touch and detects a signal generated by a touch operation, and transfers the signal to the touch controller. The touch controller receives touch information from the touch detecting apparatus, converts the touch information into touch-point coordinates, and then sends the touch-point coordinates to the processor 2280. The touch controller can also receive an instruction sent from the processor 2280 and execute the instruction. In addition, the touch control panel 2231 may be implemented by using resistive, capacitive, infrared, surface sound wave types. In addition to the touch control panel 2231, the input unit 2230 may further include the other input device 2232. Specifically, the other input device 2232 may include, but is not limited to, one or more of a physical keyboard and a function button (such as a volume control button, and a switch button).

The display unit 2240 may be configured to display information input by a user or information provided for a user and various graphic user interfaces (GUIs) of the mobile phone 2200. The display unit 2240 may include a display panel 2241, and optionally, the display panel 2241 may be configured in a form of a Liquid Crystal Display (LCD), an Organic Light-Emitting Diode (OLED). Further, the touch control panel 2231 may cover the display panel 2241. After detecting a touch operation on or near the touch control panel 2231, the touch control panel 2231 transfers the touch operation to the processor 2280 to determine a type of a touch event. Then, the processor 2280 provides a corresponding visual output on the display panel 2241 according to the type of the touch event. Although the touch control panel 2231 and the display panel 2241 serve as two independent components to implement input and input functions of the mobile phone 2200 in FIG. 22, in some embodiments, the touch control panel 2231 and the display panel 2241 may be integrated to implement the input and output functions of the mobile phone 2200.

The mobile phone 2200 may further include at least one sensor 2250, for example, a light sensor, a motion sensor and other sensors. Specifically, the light sensor may include an ambient light sensor and a proximity sensor. The ambient light sensor may adjust brightness of the display panel 2241 according to an intensity of ambient light rays. The proximity sensor may turn off the display panel 2241 and/or backlight when the mobile phone 2200 moves near an ear. As one type of motion sensor, an accelerator sensor may detect acceleration in each direction (generally three axes) and may detect magnitude and a direction of gravity when staying still, which may be used for applications for recognizing postures of a mobile terminal (for example, landscape and portrait switching, relevant games, magnetometer posture calibration), vibration recognition relevant functions (for example, pedometers and strikes), and so on. Other sensors such as a gyroscope, a barometer, a hygrometer, a thermometer, and an infrared sensor may also be configured on the mobile phone 2200, which are not described in detail here.

The audio circuit 2260, a loudspeaker 2261, and a microphone 2262 may provide an audio interface between a user and the mobile phone 2200. The audio circuit 2260 may convert received audio data into an electrical signal, and transmit the electrical signal to the loudspeaker 2261, and the loudspeaker 2261 converts the electrical signal into an audio signal for output. In another aspect, the microphone 2262 converts a collected audio signal into an electrical signal. The audio circuit 2260 receives the electrical signal, converts the electrical signal into audio data, and then outputs the audio data to the RF circuit 2210, so as to send the audio data to another mobile terminal, or outputs the audio data to the memory 2220 for further processing. The audio circuit 2260 may also include an earphone jack to provide communications between a peripheral headset and the mobile phone 2200.

The mobile phone 2200 may help a user receive and send Emails, browse webpages, access stream media through the Wi-Fi module 2270. The Wi-Fi module 2270 provides wireless broadband Internet access for the user. Although the Wi-Fi module 2270 is shown in FIG. 22, it may be understood that, the Wi-Fi module 2270 is not an essential component of the mobile phone 2200, and may completely be omitted according to demands without changing the scope of the essence of the present disclosure.

The processor 2280 is a control center of the mobile phone 2200 and is connected to all parts of the entire mobile terminal through various types of interfaces and wires. By running or executing the software programs and/or the modules stored in the memory 2220 and calling data stored in the memory 2220, the processor 2280 executes all functions and data processing of the mobile phone 2200, so as to monitor the mobile terminal on the whole. The processor 2280 may one or more processor cores. Optionally, the processor 2280 may integrate an application processor and a modem processor. The application processor mainly processes an operating system, user interfaces, application programs, and so on. The modem processor mainly processes wireless communication. It should be understood that the modem processor may also not be integrated in the processor 2280.

The mobile phone 2200 further includes the power source 2290 (for example, a battery) for supplying power to each component. Optionally, the power source may be logically connected to the processor 2280 through a power source management system, so as to implement functions such as managing charging, discharging, and power consumption through the power source management system.

Though not shown in FIG. 22, the mobile phone 2200 may further include a camera, a Bluetooth module, and so on, which are not described in detail here.

Specifically, the mobile phone 2200 (e.g., processor 2280) obtains a user identifier that logs in a current device through a resource sharing operation. The mobile phone 2200 (e.g., processor 2280) also extracts corresponding binding device information from a server based on the user identifier and displays the binding device information. Further, the mobile phone 2200 (e.g., processor 2280) obtains a device identifier selected from the displayed binding device information. In addition, the mobile phone 2200 (e.g., processor 2280) also sends the selected device identifier and resource to be shared to the server, such that the server delivers the resource to be shared to a corresponding device based on the selected device identifier.

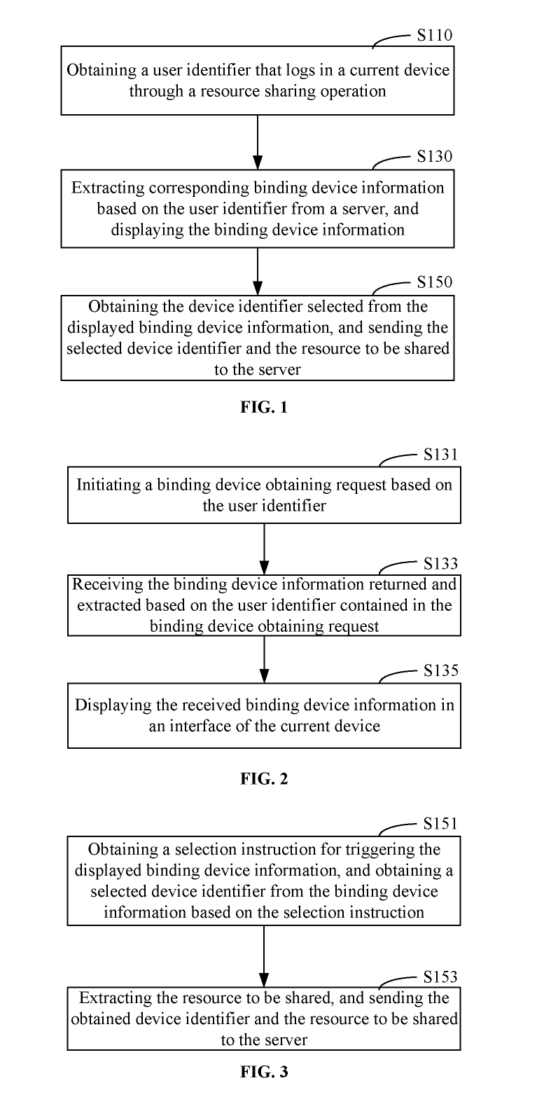

FIG. 1 illustrates a flow chart of an exemplary process for resource sharing consistent with the disclosed embodiments. The resource sharing process may be implemented on a terminal device, such as Personal Computers (PCs), laptops, smartphones, Tablet PCs, wearable smart devices, and so on. As shown in FIG. 1, the process may include the following steps.

S110: a user identifier that logs in a current device is obtained through a resource sharing operation.

When the resource sharing operation is triggered, the user identifier that logs in the current device is obtained. The resources to be shared may include bookmarks collected by a browser, contacts information in a contacts application, and so on. Correspondingly, the current device is the device that performs the resource sharing operation. For example, if the resources to be shared are bookmarks, the client for resource sharing in the current device is a browser. If the resources to be shared are contacts information, the client for resource sharing in the current device is a contacts application.

S130: based on the user identifier, corresponding binding device information is extracted from a server, and the binding device information is displayed.

The user identifier is the unique identification of the user. However, as devices used by a user are different, the same user identifier may log in different devices (e.g., a personal computer, a smartphone, etc.). Thus, the binding device information corresponding to the user identifier records the different devices that the user identifier may log in.

The binding device information records the devices that the user identifier may log in, that is, devices bound by the user identifier, such as device identifiers and device names corresponding to the devices bound by the user identifier.

Based on the user identifier that logs in the current device, the binding device information stored in the server is obtained, and the obtained binding device information is displayed on the interface of the current device for the user to check.

S150: the device identifier selected from the displayed binding device information is obtained, and the selected device identifier and the resource to be shared are sent to the server.

A binding device selection operation is triggered for the displayed binding device information. The selected binding device is the device that the user wants to share the resource with, such that the selected binding device and the current device can share the resource. More than one binding device may be selected.

The device identifier uniquely identifies the device. That is, the device identifier is a globally unique identifier (GUID, also called universally unique identifier, UUID). Based on the triggered selection operation, the selected device identifier is obtained, and the resource to be shared is also obtained, such that the selected device identifier and the resource to be shared can be sent to the backend server.

Further, the resource to be shared is obtained. The resource to be shared and the selected device identifier are packed and sent to the backend server. For example, if the resource to be shared is a bookmark, a webpage address and a title corresponding to the bookmark are extracted. The extracted webpage address, the title and the selected device identifier are packed to obtain a corresponding message, and the corresponding message is sent to the server. In addition, new message formats may also be added to share quickly other resources (e.g., eBook, calendar, etc.).

The server may deliver the resource to be shared to a corresponding device based on the selected device identifier, or to multiple devices based on more than one selected device identifiers.

The current device delivers the resource to be shared to the device corresponding to the selected device identifier through the backend server, where the device corresponds uniquely to the selected device identifier. The resource sharing among multiple devices can be realized without storing the resource in the backend server, further avoiding wasting the storage space of the server and reducing the storage cost.

FIG. 2 illustrates a flow chart of an exemplary process for extracting corresponding binding device information from a server and displaying the binding device information in S130. As shown in FIG. 2, the process may include the following steps.

S131: based on the user identifier, a binding device obtaining request is initiated.

A corresponding relationship between the user identifier and device identifiers of multiple devices is established in advance. That is, a user identifier is bound to multiple devices in advance, such that the device identifiers of the multiple devices are correlated with the user identifier.

Because the user identifier and the device identifiers are stored in a backend server, after the resource sharing operation is triggered, the binding device obtaining request is sent to the backend server, requesting the backend server to return the device identifiers corresponding to the user identifier that currently logs in the device.

S133: the binding device information that is returned and extracted based on the user identifier contained in the binding device obtaining request is received.

After the backend server receives the binding device obtaining request initiated by the current device, the server extracts the user identifier and the device identifier contained in the binding device obtaining request. Further, based on the user identifier, the server obtains the corresponding binding device information, where the device identifiers recorded in the binding device information are the device identifiers (except the device identifier contained in the binding device obtaining request) corresponding to the user identifier. Then, the server returns the binding device information to the device that initiates the binding device obtaining request.

S135: the received binding device information is displayed in an interface of the current device.

After the binding device information returned from the backend server is received, the binding device information is displayed in the interface of the current device for the user to check and select the device for resource sharing.

Further, the binding device information includes device names and device identifiers corresponding to one or more devices. Therefore, the device names corresponding to the one or more devices are displayed in the form of a list in the interface of the current device for the user to check.

The binding device information obtained from the server is displayed in the interface of the current device for the user to select, greatly improving the interaction of resource sharing. In addition, the user can share the resource to any binding device, improving the flexibility of resource sharing.

FIG. 3 illustrates a flow chart of an exemplary process for obtaining the device identifier selected from the displayed binding device information and sending the selected device identifier and resource to be shared to a server consistent with the disclosed embodiments. As shown in FIG. 3, the process may include the following steps.

S151: a selection instruction triggered on the displayed binding device information is obtained, and a selected device identifier is obtained from the binding device information based on the selection instruction.

After the selection operation is triggered on the binding device information displayed in an interface of a current device is detected, the corresponding selection instruction is generated. The device identifier of the device that shares the resource can be obtained by obtaining the triggered selection instruction.

Further, the binding device information is displayed to the user in the form of device names. That is, the device names corresponding to the binding devices are displayed in the interface of the current device in the form of a name list. At this time, the selection operation for triggering the device name by the user is detected to generate the corresponding selection instruction. Further, based on the device name corresponding to the selection instruction, the corresponding device identifier is extracted from the binding device information. For example, a device name may be Don's iPhone. The device name may be named by the user or is preset by a manufacturer.

S153: the resource to be shared is extracted, and the obtained device identifier and the resource to be shared are sent to the server.

In addition to the device name binding the user identifier that logs in the current device, the binding device information also records the device identifier, and a relationship between the device name and the device identifier. Therefore, based on the relationship between the device name and the device identifier contained in the binding device information, the device identifier corresponding to the device name of the device for resource sharing can be extracted.

In certain embodiments, if the resource to be shared is a bookmark, S153 may further include the following steps. A web address and a title corresponding to the bookmark are extracted. The extracted web address, the tile and the device identifier are packed to obtain a corresponding message, and the obtained message is sent to a server.

After the bookmark to be shared is selected by the user, the web address and the title corresponding to the bookmark are extracted, such that the web address and the title corresponding to the bookmark and the device identifier corresponding to a target device can be packed to obtain the message. Then, the obtained message is sent to the backend server.

In certain embodiments, an active current device receives the resource sent from the server according to the device identifier.

The current device shares the resource with other devices. In addition, the current device also receives the resource sent from any other device through the server, sharing the resource from any other device.

After the server receives the device identifier and the resource sent from any other device, based on the received device identifier, the target device (i.e., the current device) that other devices share the resource with is obtained, and the active current device receives the resource sent from the server, realizing resource sharing between other devices and the current device.

In addition, the active current device establishes persistent TCP connections with the backend server to fetch each URL or other resources. The current device sends heartbeat messages to the server according to certain time interval, such that the server detects that the current device is in an active status.

In addition, the resource (e.g., a bookmark message) sent by other devices via a message server may be received in real time by an asynchronous (non-blocking) socket recv method.

The active current device receives the resource sent from the server, realizing real-time resource sharing among multiple devices and ensuring the real-time resource sharing.

FIG. 4 illustrates a flow chart of another exemplary process for resource sharing consistent with the disclosed embodiments. As shown in FIG. 4, before performing S130 (FIG. 1), the process may also include the following steps.

S310: a user identifier that logs in a current device and a device identifier corresponding to a device that requests to be bound are obtained through a triggered device binding instruction.

Before performing resource sharing, the user identifier is bound to multiple devices. Specifically, the user identifier that logs in the current device is obtained from the device to be bound. The device binding instruction that correlates the device to be bound with the user identifier is triggered. At this time, based on the device binding instruction, the device identifier corresponding to the device to be bound and the user identifier that logs in the device to be bound are obtained.

S330: based on the device identifier corresponding to the device that requests to be bound, binding device information corresponding to the user identifier that logs in the current device is generated, and the generated binding device information is stored in a server.

The device identifier corresponding to the device to be bound is correlated with the user identifier to obtain the binding device information. The binding device information is uploaded to the backend server to store.

Further, based on the user identifier, the backend server stores the uploaded device identifiers in groups. That is, the user identifier is a group name, and the device identifiers corresponding to the user identifier are stored in the same group. The device identifiers stored in the group are the binding device information corresponding to the user identifier.

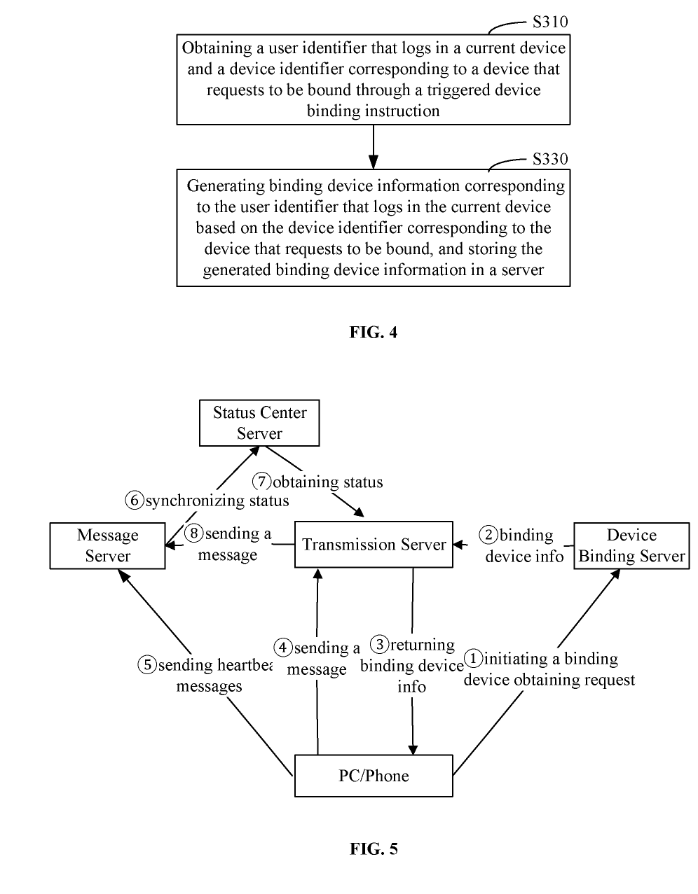

FIG. 5 illustrates a schematic application diagram of an exemplary process for resource sharing consistent with the disclosed embodiments. As shown in FIG. 5, a current device is a personal computer or a smartphone (e.g., an iPhone, an Android phone, etc.). When a triggered resource sharing operation (e.g., a user wants to share a webpage displayed currently in a browser) is detected, the current device finds out that the user wants to share the webpage currently displayed.

A user identifier (e.g., a qq account that a user logs in a browser) that logs in the current device is obtained. Based on the user identifier that logs in the current device, a binding device obtaining request is sent to a device binding server using the HTTP. Based on the user identifier in the binding device obtaining request, the device binding server obtains the corresponding binding device information, and sends the obtained binding device information to a transmission server. The transmission server returns the binding device information to the current device.

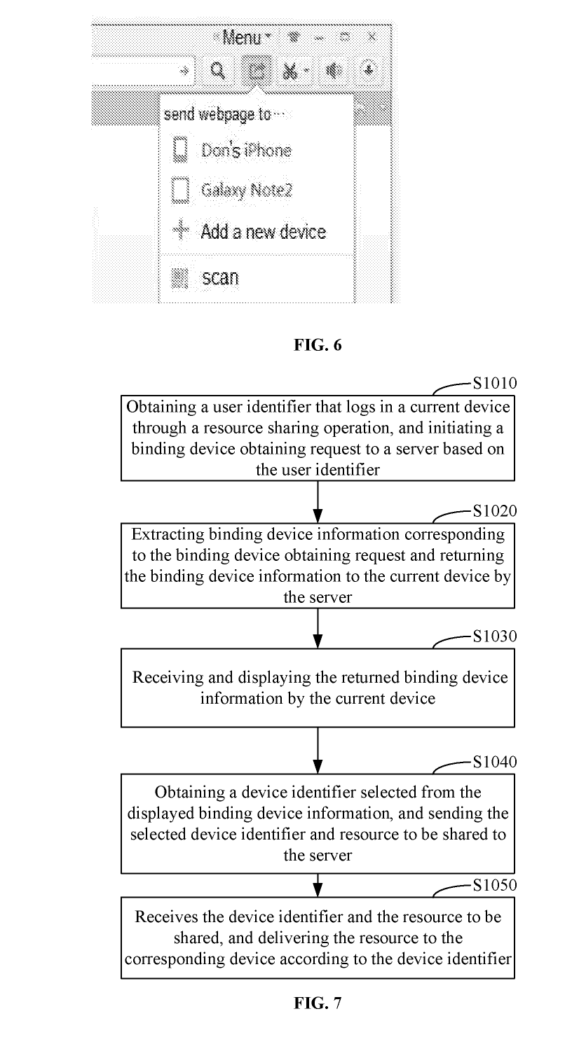

After the current device receives the binding device information, the current device extracts device names contained in the binding device information and displays the device names in an interface. FIG. 6 illustrates a schematic diagram of an exemplary display interface of a current client consistent with the disclosed embodiments. As show in FIG. 6, a drop down menu is displayed as the interface for the user to select the device. For example, in FIG. 6, two smart phones are listed. The user can also add new devices by using the “Add a new device” selection. Further, the user can also add new device by scanning an ID code from the new device to be added.

The user can select a particular device, and a selection operation for a device name triggered by the user is obtained, such that a target device that shares the webpage can be obtained. The device names corresponding to the one or more devices are displayed in the form of a list in an interface of a current device for the user to check.

A selection instruction generated based on the selection operation is obtained, such that a device name of a device that shares the webpage can be obtained. A device identifier corresponding to the device name is extracted from device property, where the device property contains a device name, a device GUID, etc. It should be noted that the device property is encoded before the device property is sent to a backend device binding server.

A webpage address and a title corresponding to the webpage to be shared are obtained. The obtained webpage address, the title and the device identifier of the target device are packed to obtain a message. Then, returning to FIG. 5, the packed message is sent to a transmission server.

The message server determines whether a target device is in an active status. When the message server receives heartbeat messages from the target device in certain time interval, the message server determines that the target device is in the active status. At this time, the message server synchronizes the target device status to a status center server.

After the transmission server receives the packed message, the transmission server inquires the status of the target device from the status center server. That is, the transmission server inquires whether the device corresponding to the device identifier contained in the message is in the active status. If the device is in the active status, the transmission server sends the packed message to the message server. The message server sends the message to the target device which is in the active status. At this time, based on a push notification mechanism, the client in the target device directly displays the webpage to be shared by a push system.

If the target device is not in the active status, the message is cached. When the target device enters into the active status, the message can be sent by the message server. An offline mechanism of resource sharing is realized, and real-time resource sharing is also realized.

In the above resource sharing process, the resource to be shared is only delivered by the server. Therefore, the resource does not need to be stored in the server. That is, the user does not need to log in the server via certain device to obtain the resource, avoiding wasting the storage space of the server, further reducing the storage costs.

The resource to be shared can be any resource obtained by the client. Thus, any content can be shared, greatly improving the scalability of resource sharing.

FIG. 7 illustrates a flow chart of an exemplary process for resource sharing consistent with the disclosed embodiments. As shown in FIG. 7, the process may include the following steps.

S1010: a user identifier that logs in a current device is obtained through a resource sharing operation, and a binding device obtaining request is initiated to a server based on the user identifier.

S1020: the server extracts binding device information corresponding to the binding device obtaining request and returns the binding device information to the current device.

After the current device initiates the binding device obtaining request, the backend server receives the binding device obtaining request and extracts the user identifier from the binding device obtaining request. Then, based on the extracted user identifier, the binding device information corresponding to the user identifier is obtained by searching the user identifier in the server that stores the binding device information.

S1030: the current device receives and displays the returned binding device information.

S1040: a device identifier selected from the displayed binding device information is obtained, and the selected device identifier and resource to be shared are sent to the server.

S1050: the server receives the device identifier and the resource to be shared, and delivers the resource to the corresponding device according to the device identifier.

After receiving the device identifier and the resource to be shared, based on the device identifier, the backend server sends the resource to the corresponding device. Specifically, the backend server receives a message that the current device packs the device identifier and the resource to be shared. Therefore, before delivering the message to the device, the server decodes the received message and re-packs the message. Then, the server delivers the re-packed message to the corresponding device.

The process that the backend server decodes the message and re-packs the message further includes the followings. The backend server decodes the message to obtain message type, a webpage address and a title corresponding to the resource, a device name and a device identifier contained in the message. Further, the backend server determines whether the webpage address exceeds a preset threshold value. If the webpage address exceeds the preset threshold value, it means that the webpage address is too long, and the webpage address needs to be converted. If the webpage address does not exceed the preset threshold value, no further operation is needed; and the backend server re-packs the message and delivers the re-packed message to the device corresponding to the device identifier contained in the message to complete the resource sharing process.

The above resource sharing process realizes real-time resource sharing among multiple devices by using a message delivering mechanism, further improving the real-time resource sharing.

FIG. 8 illustrates a flow chart of an exemplary process for obtaining a device identifier contained in the displayed binding device information and sending the selected device identifier and resource to be shared to a server shown in FIG. 7 consistent with the disclosed embodiments. As shown in FIG. 8, S1040 in FIG. 7 may include the following steps.

S1041: a selection instruction for triggering the binding device information displayed in the current device is obtained, and a selected device identifier is obtained from the binding device information based on the selection instruction.

S1043: the resource to be shared is extracted, and the obtained device identifier and the resource to be shared are sent to a server.

In certain embodiments, if the resource to be shared is a bookmark, S1043 may include the followings. A webpage address and a title corresponding to the bookmark are extracted. The extracted webpage address, the title and the device identifier are packed to obtain a corresponding message. Then, the message is sent to a server.

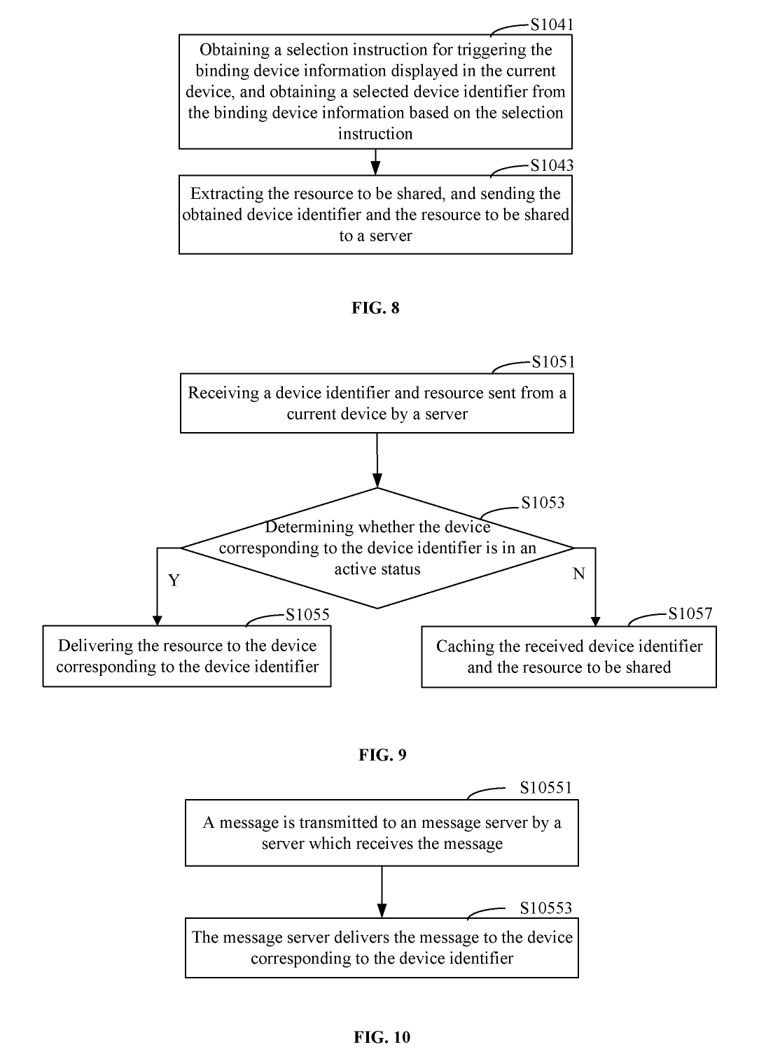

FIG. 9 illustrates a flow chart of an exemplary process for receiving the device identifier and resource to be shared by a server, and sending the resource to be shared to a corresponding device based on the device identifier shown in FIG. 7 consistent with the disclosed embodiments. As shown in FIG. 9, S1050 in FIG. 7 may include the following steps.

S1051: the server receives a device identifier and resource sent from a current device.

Specifically, the backend server receives the device identifier and the resource sent from the current device, where the device identifier corresponds to a target device that shares the resource.

S1053: whether the device corresponding to the device identifier is in an active status is determined. If the device is in the active status, the process goes to S1055. If the device is not in the active status, the process goes to S1057.

After the device establishes TCP persistent connections with the backend server, the device sends heartbeat messages to the server according to certain time interval. At this time, the server which receives the heartbeat messages detects that the device is in the active status. If the device does not send the heartbeat messages, it is determined that the device is in the inactive status (i.e., offline status).

That is, whether a client running in the device corresponding to the device identifier is in the active status is determined. If the client is in the active status (i.e., online status), for the client that runs in smartphones and tablet PCs, the client runs in the frontend or backend; for the client that runs in PCs, the client runs in the frontend. Therefore, the resource can be directly sent. If the client is in the inactive status (i.e., offline status), the received device identifier and the resource are cached. The resource is delivered when the client running in the device corresponding to the device identifier is in the active status.

S1055: the resource is directly delivered to the device corresponding to the device identifier.

After determining that the client running in the device corresponding to the device identifier is in the active status, the resource is directly delivered. The real-time resource sharing among multiple devices is realized, ensuring the real-time resource sharing.

S1057: the received device identifier and the resource to be shared are cached.

The received device identifier and resource to be shared are cached in the backend server. The resource is delivered when the client running in the device corresponding to the device identifier is in the active status. At this time, the interface of the device displays the resource delivered by the server, realizing resource sharing among multiple devices.

In the above resource sharing process, the resource is delivered only when the device is in the active status, such that the resource sharing among multiple devices realizes an offline mechanism. Therefore, the status of the current device does not affect the resource sharing, further improving the stability of the resource sharing.

In certain embodiments, S1051 may include the following steps. A message sent to the server is received and a device identifier is extracted from the message.

FIG. 10 illustrates a flow chart of an exemplary process for delivering resource to a device corresponding to a device identifier as shown in FIG. 9. As shown in FIG. 10, S1055 in FIG. 9 may include the following steps.

S10551: a message is transmitted to a message server by a server which receives the message.

In addition to the server which is used to receive the message, the backend also includes the message server which is used to transmit the message among multiple devices.

In certain embodiments, after the server receives the message, the server decodes and re-packs the message, and then transmits the re-packed message to the message server.

S10553: the message server delivers the message to the device corresponding to the device identifier.

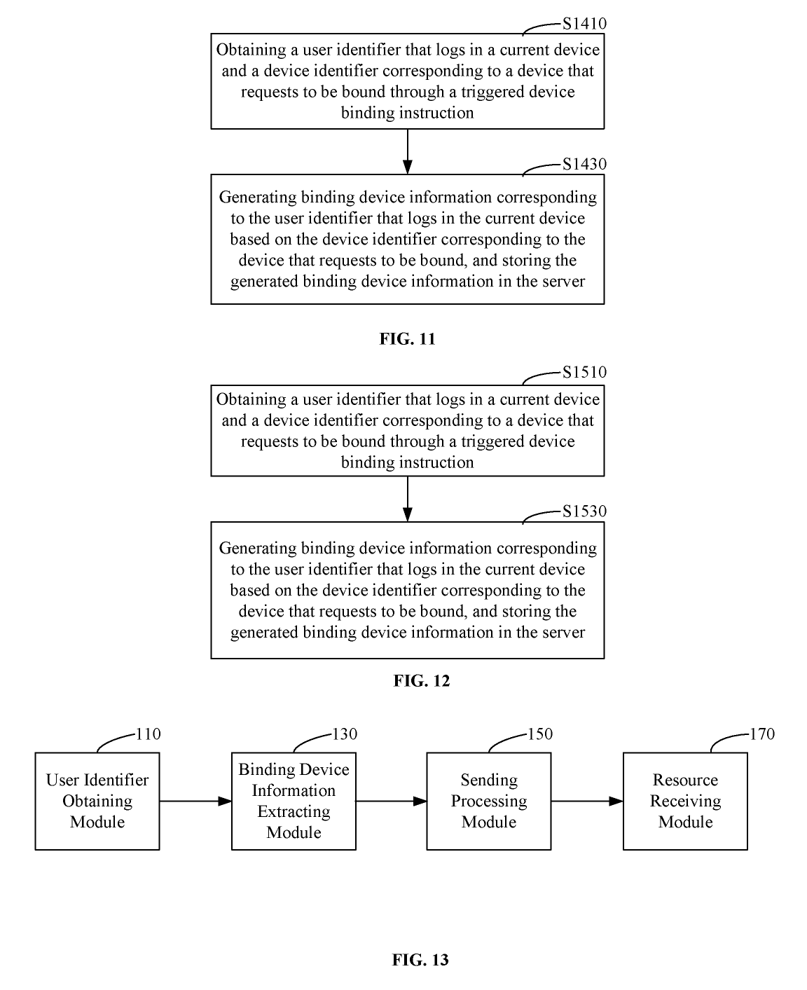

FIG. 11 illustrates a flow chart of another exemplary process for sharing resource consistent with the disclosed embodiments. As shown in FIG. 11, before performing S1020 (FIG. 7), the process may also include the following steps.

S1410: a user identifier that logs in a current device and a device identifier corresponding to a device that requests to be bound are obtained through a triggered device binding instruction.

S1430: based on the device identifier corresponding to the device that requests to be bound, binding device information corresponding to the user identifier that logs in the current device is generated, and the generated binding device information is stored in the server.

In certain embodiments, S1410 may include the following steps. The message sent to the server is received and the device identifier is extracted from the message.

FIG. 12 illustrates a flow chart of another exemplary process for sharing resource consistent with the disclosed embodiments. As shown in FIG. 12, before performing S1020, the process may also include the following steps.

S1510: a user identifier that logs in a current device and a device identifier corresponding to a device that requests to be bound are obtained through a triggered device binding instruction.

S1530: based on the device identifier corresponding to the device that requests to be bound, the binding device information corresponding to the user identifier that logs in the current device is generated, and the generated binding device information is stored in the server.

FIG. 13 illustrates a schematic structure diagram of an exemplary system for sharing resource consistent with the disclosed embodiments. As shown in FIG. 13, the resource sharing system may include a user identifier obtaining module 110, a binding device information extracting module 130, a sending processing module 150 and a resource receiving module 170.

The user identifier obtaining module 110 is configured to obtain a user identifier that logs in a current device through a resource sharing operation.

The user identifier obtaining module 110 obtains the user identifier that logs in the current device when the resource sharing operation is triggered. The resources to be shared may include bookmarks collected by a browser, contacts information in a contacts application, and so on. Correspondingly, the current device is the device that performs the resource sharing operation. For example, if the resources to be shared are bookmarks, the client for resource sharing in the current device is a browser. If the resources to be shared are contacts information, the client for resource sharing in the current device is a contacts application.

The binding device information extracting module 130 is configured to, based on the user identifier, extract corresponding binding device information from a server and display the binding device information.

The user identifier is the unique identification of the user. However, as devices used by a user are different, the same user identifier may log in different devices (e.g., a personal computer, a smartphone, etc.). Thus, the binding device information corresponding to the user identifier records the different devices that the user identifier logs in.

The binding device information records the device that bound with the user identifier logged in the current device, that is, the device bound to the user identifier, such as a device identifier and a device name corresponding to the device bound to the user identifier.

Based on the user identifier that logs in the current device, the binding device information extracting module 130 obtains the binding device information stored in the server, and displays the obtained binding device information in an interface of the current device for the user to check.

The sending processing module 150 is configured to obtain a device identifier selected from the displayed binding device information, and send the selected device identifier and resource to be shared to the server.

The binding device selection operation is triggered for the displayed binding device information. The selected binding device is the device that the user wants to share the resource with, such that the selected binding device and the current device can share the resource.

The device identifier uniquely identifies the device. That is, the device identifier is a Globally Unique Identifier (GUID, also called Universally Unique Identifier, UUID). Based on the selection operation triggered by the displayed binding device information, the sending processing module obtains the selected device identifier and the resource to be shared, and sends the selected device identifier and the resource to be shared to the backend server.

Further, the sending processing module obtains the resource to be shared. The resource to be shared and the selected device identifier are packed to send to the backend server. For example, if the resource to be shared is a bookmark, a webpage address and a title corresponding to the bookmark are extracted. The extracted webpage address, the title and the selected device identifier are packed to obtain a corresponding message, and the corresponding message is sent to the server.

The resource to be shared is sent to the corresponding device according to the device identifier selected by the server.

The current device sends the resource to be shared to the device corresponding to the selected device identifier through the backend server, where the device corresponds uniquely the selected device identifier. The resource receiving module 170 in the device receives the resource to be shared. The resource sharing among multiple devices can be realized without storing the resource in the backend server, further avoiding wasting the storage space of the server and reducing the storage costs.

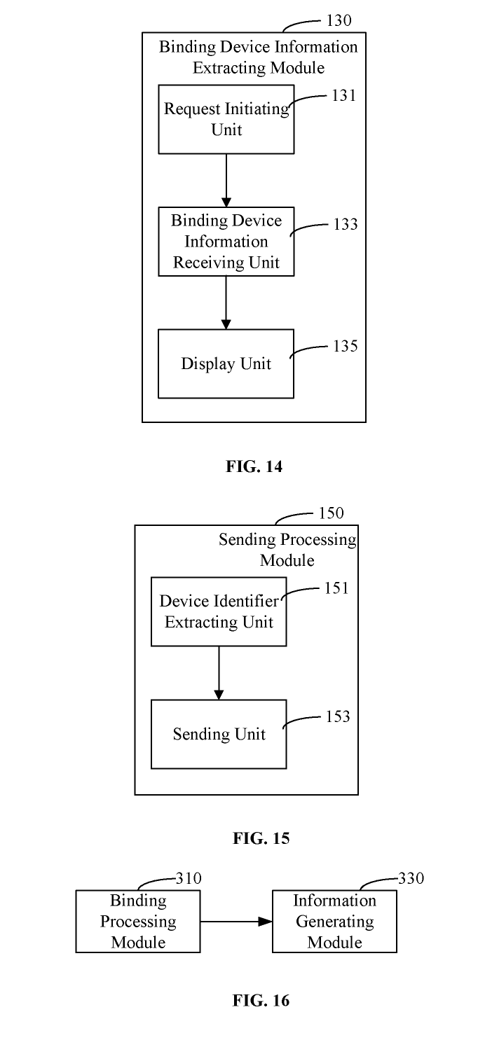

FIG. 14 illustrates a schematic structure diagram of an exemplary binding device information extracting module 130 shown in FIG. 13 consistent with the disclosed embodiments. As shown in FIG. 14, the binding device information extracting module 130 may include a request initiating unit 131, a binding device information receiving unit 133 and a display unit 135.

The request initiating unit 131 is configured to, based on a user identifier, initiate a binding device obtaining request.

A corresponding relationship between the user identifier and device identifiers of multiple devices is established in advance. That is, a user identifier is bound to multiple devices in advance, such that the device identifiers of the multiple devices are correlated with the user identifier.

Because the user identifier and the device identifier are stored in the backend server, after the resource sharing operation is triggered, the request initiating unit 131 sends the binding device obtaining request to the backend server, requesting the backend server to return the device identifiers corresponding to the user identifier that currently logs in the device.

The binding device information receiving unit 133 is configured to receive the binding device information extracted based on the user identifier contained in the binding device obtaining request.

After the backend server receives the binding device obtaining request initiated by the current device, the backend server extracts the user identifier and the device identifier contained in the binding device obtaining request. Then, based on the user identifier, the corresponding binding device information is obtained. The device identifiers recorded in the binding device information are the device identifiers (except the device identifier contained in the binding device obtaining request) corresponding to the user identifier. Further, the binding device information is returned to the device that initiates the binding device obtaining request.

The display unit 135 is configured to display the received binding device information in an interface of the current device.

After the binding device information returned from the backend server is received, the binding device information is displayed in the interface of the current device for the user to check and select the device that shares the resource.

Further, the binding device information includes the device names and the device identifiers corresponding to one or more devices. Therefore, the device names corresponding to the one or more devices are displayed in the form of a list in the interface of the current device for the user to check.

The binding device information obtained from the server is displayed in the interface of the current device for the user to select, greatly improving the interaction of resource sharing. In addition, the user can share the resource with any other binding device, improving the flexibility of resource sharing.

FIG. 15 illustrates a schematic structure diagram of an exemplary sending processing module consistent with the disclosed embodiments. As shown in FIG. 15, the sending processing module 150 may include a device identifier extracting unit 151 and a sending unit 153.

The device identifier extracting unit 151 is configured to obtain a selection instruction for triggering the displayed binding device information, and obtain a device identifier selected from the binding device information based on the selection instruction.

After the device identifier extracting unit 151 detects the selection operation for triggering the binding device information displayed in the interface of the current device, the corresponding selection instruction is generated. The device identifier of the device that shares the resource can be obtained by obtaining the triggered selection instruction.

Further, the binding device information is displayed to the user in the form of device names. That is, the device names corresponding to the binding devices are displayed in the interface of the current device in the form of a name list. At this time, the device identifier extracting unit 151 detects the selection operation for triggering the device name by the user to generate the corresponding selection instruction. Moreover, based on the device name corresponding to the selection instruction, the corresponding device identifier is extracted from the binding device information. For example, a device name may be Don's iPhone. The device name may be named by the user or is preset by a manufacturer.

The sending unit 153 is configured to extract the resource to be shared, and send the obtained device identifier and the resource to be shared to a server.

In addition to the device name binding the user identifier that logs in the current device, the binding device information also includes the device identifier, and a relationship between the device name and the device identifier. Therefore, the device identifier extracting unit 151 can extract the device identifier corresponding to the device name of the resource sharing device based on the relationship between the device name and the device identifier contained in the binding device information.

In certain embodiments, if the resource to be shared is a bookmark, the sending unit 153 is also configured to extract a web address and a title corresponding to the bookmark, pack the extracted web address, the title and device identifier to obtain a corresponding message, and send the obtained message to the server.

After the user selects the bookmark to be shared, the sending unit 153 extracts the web address and the title corresponding to the bookmark, such that the web address and the title corresponding to the bookmark and the device identifier corresponding to a target device can be packed to obtain the message. Then, the sending unit 153 sends the obtained message to the backend server.

In certain embodiments, the system may also include a resource receiving unit. When the current device is in an active, the resource receiving unit is configured to receive the resource delivered by the server according to the device identifier.

The current device shares the resource with other devices, and also receives the resource delivered by other devices through the server to share the resource from other devices.

After the server receives the device identifier and the resource sent from other devices, based on the received device identifier, the target device (i.e., the current device) that other devices share the resource with is obtained, and the active current device receives the resource delivered from the server, realizing resource sharing between other devices and the current device.

In addition, the active current device establishes Transmission Control Protocol (TCP) persistent connections with the backend server. The current device sends heartbeat messages to the server according to certain time interval, such that the server detects that the current device is in the active status.

The active current device receives the resource to be shared delivered from the server, realizing real-time resource sharing among multiple devices and ensuring the real-time resource sharing. In certain embodiments, the resource receiving unit is also configured to receive message sent to the server, and extract the device identifier from the message.

FIG. 16 illustrates a schematic structure diagram of another exemplary system for sharing resource consistent with the disclosed embodiments. As shown in FIG. 16, the system may include a binding processing module 310 and an information generating module 330.

The binding processing module 310 is configured to obtain a user identifier that logs in the current device and a device identifier corresponding to the device that requests to be bound through the triggered device binding instruction.

Before sharing the resource, the binding processing module 310 also binds the user identifier with multiple devices. Specifically, the binding processing module 310 obtains the user identifier that logs in the current device from the device to be bound and triggers the device binding instruction that correlates the device to be bound with the user identifier. At this time, based on the device binding instruction, the device identifier corresponding to the device to be bound and the user identifier that logs in the device to be bound are obtained.

The information generating module 330 is configured to, based on the device identifier corresponding to the device that requests to be bound, generate binding device information corresponding to the user identifier that logs in the current device, and store the generated binding device information in a server.

The information generating module 330 correlates the device identifier corresponding to the device to be bound with the user identifier to obtain the binding device information, and uploads the binding device information to the backend server.

Further, based on the user identifier, the backend server stores the uploaded device identifiers in groups. That is, the user identifier is a group name, and the device identifiers corresponding to the user identifier is stored in the same group. The device identifiers stored in the group is the binding device information corresponding to the user identifier.

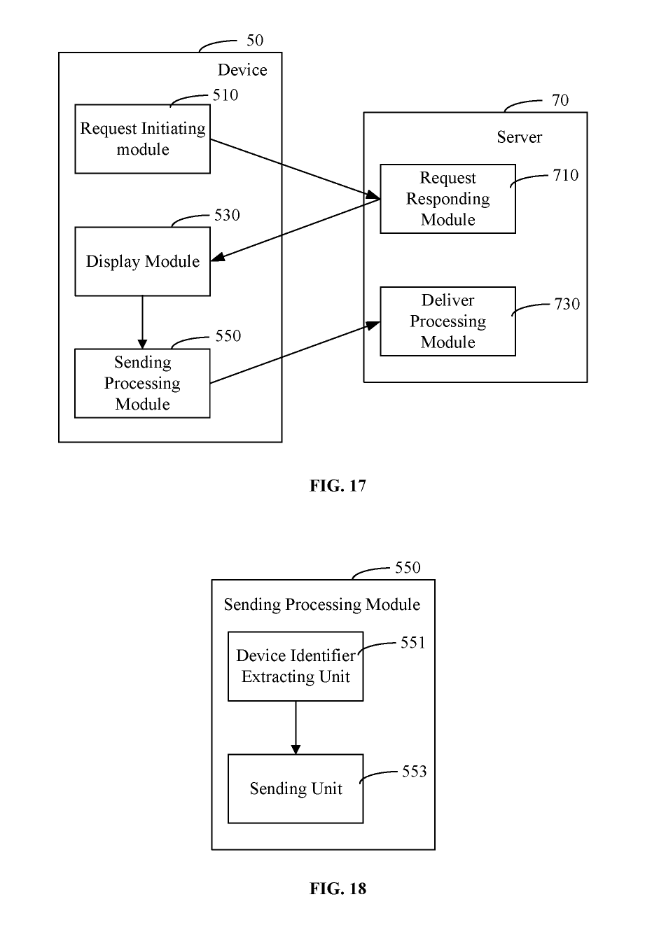

FIG. 17 illustrates a schematic structure diagram of an exemplary system for sharing resource consistent with the disclosed embodiments. As shown in FIG. 17, the resource sharing system may include a device 50 and a server 70 that communicates with the device. The device 50 may include a request initiating module 510, a display module 530 and a sending processing module 550. The server 70 may include a request responding module 710 and a deliver processing module 730.

The request initiating module 510 is configured to obtain a user identifier that logs in a current device through a resource sharing operation, and initiate a binding device obtaining request to the server 70 based on the user identifier.

The request responding module 710 is configured to extract and obtain binding device information corresponding to the binding device obtaining request, and return the binding device information to the current device 50.

After the current device initiates the binding device obtaining request, the request responding module 710 in the backend server 70 receives the binding device obtaining request and extracts the user identifier from the binding device obtaining request. Based on the obtained user identifier, the binding device information corresponding to the user identifier is searched and obtained from the server that stores the binding device information.

The display module 530 is configured to receive and display the binding device information. The sending processing module 550 is configured to obtain the device identifier selected from the displayed binding device information, and send the selected device identifier and the resource to be shared to the server 70.

The deliver processing module 730 is configured to receive the device identifier and the resource to be shared, and send the resource to be shared to the corresponding device according to the device identifier.

When the deliver processing module 730 in the backend server 70 receives the device identifier and the resource to be shared sent from the current device, the deliver processing module 730 delivers the resource to be shared based on the device identifier.

Specifically, the deliver processing module 730 receives the message that the current device packs the device identifier and the resource to be shared. Before delivering the message, the deliver processing module 730 decodes and re-packs the received message. Then, the deliver processing module 730 delivers the re-packed message to the corresponding device.

The process for decoding and re-packing the message by the deliver processing module 730 may include the followings. The deliver processing module 730 decodes the message to obtain message type, a webpage address and a title corresponding to the resource, a device name and a device identifier contained in the message. Further, the deliver processing module 730 determines whether the webpage address exceeds a preset threshold value.

If the webpage address exceeds the preset threshold value, it means that the webpage address is too long, and the webpage address needs to be converted. If the webpage address does not exceed the preset threshold value, no further operation is needed; and the deliver processing module 730 re-packs the message and delivers the re-packed message to the device corresponding to the device identifier contained in the message to complete the resource sharing process.

The above resource sharing process realizes real-time resource sharing among multiple devices by using a message delivering mechanism, further improving the real-time resource sharing.

FIG. 18 illustrates a schematic structure diagram of an exemplary sending processing module shown in FIG. 17 consistent with the disclosed embodiments. As shown in FIG. 18, the sending processing module 550 may include a device identifier extracting unit 551 and a sending unit 553.

The device identifier extracting unit 551 is configured to obtain a selection instruction for triggering the displayed binding device information, and obtain a device identifier selected from the binding device information based on the selection instruction.

The sending unit 553 is configured to extract the resource to be shared, and send the obtained device identifier and the resource to be shared to the server.

In certain embodiments, if the resource to be shared is a bookmark, the sending unit 553 is also configured to extract a webpage address and a title corresponding to the bookmark, pack the extracted webpage address, the title and the device identifier to obtain the corresponding message, and send the obtained message to the server 70.

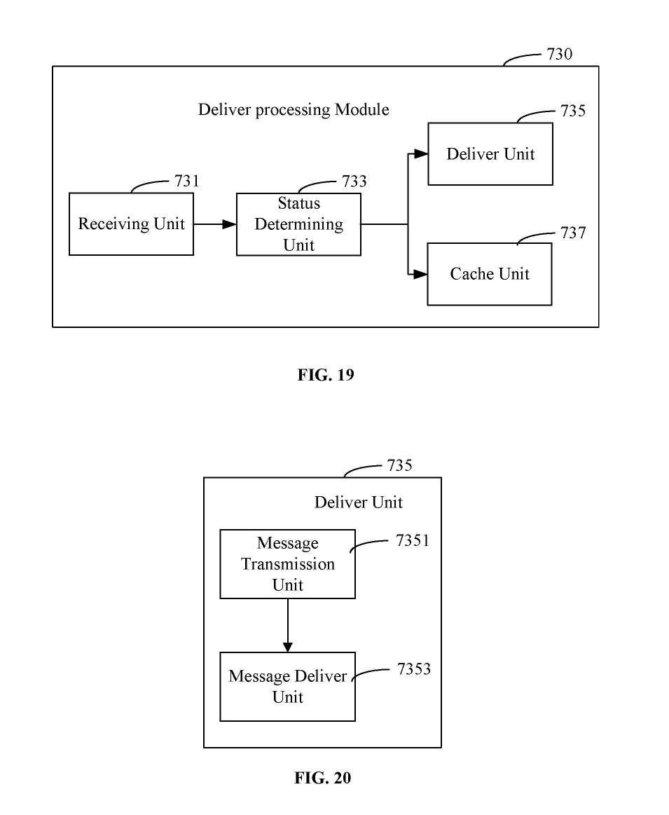

FIG. 19 illustrates a schematic structure diagram of an exemplary deliver processing module shown in FIG. 17 consistent with the disclosed embodiments. As shown in FIG. 19, the deliver processing module 730 may include a receiving unit 731, a status determining unit 733, a deliver unit 735 and a cache unit 737.

The receiving unit 731 is configured to receive a device identifier and resource to be shared.

The backend server 70 (the receiving unit 731) receives the device identifier and the resource sent from a current device, where the device identifier is the device identifier corresponding to a target device that shares the resource.

The status determining unit 733 is configured to determine whether the device corresponding to the device identifier is in an active status. If the device is in the active status, the status determining unit 733 informs the deliver unit 735. If the device is not in the active status, the status determining unit 733 informs the cache unit 737.

After the device 50 establishes TCP persistent connections with the backend server 70, the device 50 sends heartbeat messages to the backend server according to certain time interval. At this time, because the status determining unit 733 of the server 70 receives the heartbeat messages, the server 70 detects that the device 50 is in the active status. If the status determining unit 733 does not receive the heartbeat message sent from the device 50, the server determines that the device is not in the active status.

The status determining unit 733 determines whether a client running in the device corresponding to the device identifier is in the active status. If the client is in the active status, for the client that runs in smartphones and tablet PCs, the client runs in the frontend or backend; for the client that runs in PCs, the client runs in the frontend. Therefore, the status determining unit 733 informs the deliver unit 735 to deliver the resource directly. If the client is in the inactive status, the status determining unit 733 informs the cache unit 737 to cache the received device identifier and the resource. The resource is delivered when the client running in the device corresponding to the device identifier is in the active status.

The deliver unit 735 is configured to deliver the resource to the device corresponding to the device identifier.

When the status determining unit 733 determines that the client running in the device corresponding to the device identifier is in the active status, the deliver unit 735 delivers the resource to be shared directly, realizing real-time resource sharing among multiple devices, further ensuring real-time resource sharing.

The cache unit 737 is configured to cache the received device identifier and the resource to be shared. The cache unit 737 caches the received device identifier and the resource to be shared in the backend server 70. When the client of the device corresponding to the device identifier enters into the active status, the deliver unit 735 delivers the resource. At this time, the resource is displayed in the interface of the device, realizing resource sharing among multiple devices.

In certain embodiments, the receiving unit 731 is also configured to receive the message sent to the server 70 and extract the device identifier contained in the message.

FIG. 20 illustrates a schematic structure diagram of an exemplary deliver unit shown in FIG. 19 consistent with the disclosed embodiments. As shown in FIG. 20, the deliver unit 735 may include a message transmission unit 7351 and a message deliver unit 7353.

The message transmission unit 7351 is configured to transmit a message from the server that receives the message to a message server.

In addition to the server that receives the message, the backend also includes the message server configured to transmit the message among multiple devices.

In certain embodiments, after the message receiving server receives the message, the message transmission unit 7351 decodes and re-packs the message, and then transmits the re-packed message to the message server.

The message deliver unit 7353 is configured to deliver the message to the device corresponding to the device identifier through the message server.

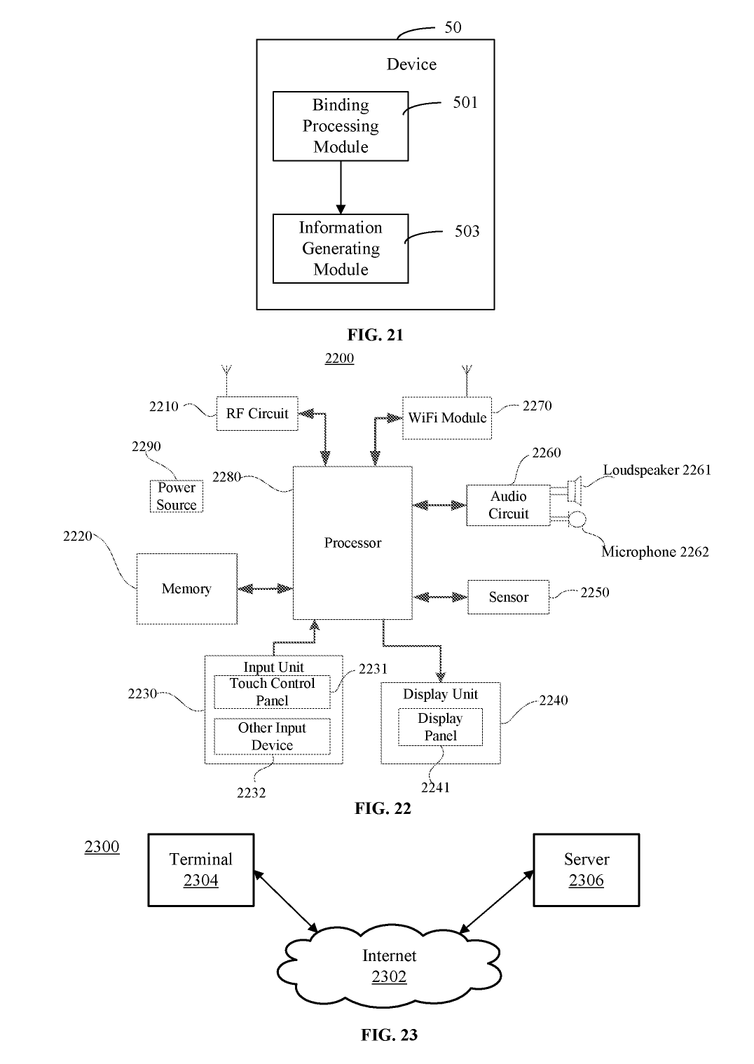

FIG. 21 illustrates a schematic structure diagram of another exemplary device for sharing resource consistent with the disclosed embodiments. As shown in FIG. 21, the device 50 may include a binding processing module 501 and an information generating module 503.

The binding processing module 501 is configured to obtain a user identifier that logs in a current device and a device identifier corresponding to a device that requests to be bound through a triggered device binding instruction.

The information generating module 503 is configured to generate the binding device information corresponding to the user identifier that logs in the current device based on the device identifier corresponding to the device that requests to be bound, and store the generated binding device information in the server 70.

In the above method and system for resource sharing, the user identifier that logs in the current device is obtained through the resource sharing operation. Based on the user identifier that logs in the current device, the corresponding binding device information is extracted and obtained from the server. The obtained binding device information is displayed. Further, the device identifier selected from the displayed binding device information is obtained and displayed, where the device identifier corresponds to the target device that shares the resource. The selected device identifier and the resource to be shared are sent to the server. Correspondingly, based on the selected device identifier, the server delivers the resource to the corresponding device, such that the device corresponding to the device identifier (i.e., the target device that shares the resource) can receive the resource delivered by the server. Because the resource to be shared is delivered by the server, the resource does not need to be stored in the server. The user does not need to log in the server via certain device to obtain the resource, avoiding wasting the storage space of the server, further reducing the storage costs.

Each functional unit in the embodiments of the present invention may be integrated into a processing module, or may be a separate physical unit. Alternatively, two or more than two functional units are integrated into one module. The above integrated modules may be implemented with hardware, or software function modules. Each of the above apparatuses may execute the methods in the method embodiments, which are not repeated herein.

The respective embodiments in the disclosure are described in a stepwise manner, the same or similar parts between the respective embodiments can be referred to with each other, and the emphasized explanations of the respective embodiments are the difference from other embodiments. Especially, for the apparatus embodiments, since they are substantially similar to the method embodiments, the description is comparatively simple, and relevant part can be referred to the explanation of the part of the method embodiments.

Those skilled in the art may implement the described functionality in varying ways for each particular application, but such implementation decisions should not be interpreted as being a departure from the scope of the present invention.

Those skilled in the art should understand that all or part of the steps in the above method may be executed by relevant hardware instructed by a program, and the program may be stored in a computer-readable storage medium such as a removable hard disk, a read-only memory (ROM), a random access memory (RAM), a magnetic disk, an optical disk, and so on.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems for resource sharing, a device obtains a user identifier that logs in a current device through a resource sharing operation. The device also extracts corresponding binding device information from a server based on the user identifier and displays the binding device information. Further, the device obtains a device identifier selected from the displayed binding device information. In addition, the device also sends the selected device identifier and resource to be shared to the server, such that the server delivers the resource to be shared to a corresponding device based on the selected device identifier. Therefore, the resource does not need to be stored in the server. Thus, complexity for sharing resource(s) can be simplified and sharing cost can be significantly reduced.

What is claimed is:

1. A resource sharing method, comprising:
obtaining a user identifier that logs in a current device through a resource sharing operation;
based on the user identifier, extracting corresponding binding device information from a server;
displaying the binding device information on the current device;
obtaining a device identifier selected from the displayed binding device information; and
sending the selected device identifier and resource to be shared with a device corresponding to the selected device identifier to the server, such that the server delivers the resource to be shared to the corresponding device based on the selected device identifier.

2. The method according to claim 1, wherein extracting corresponding binding device information from a server based on the user identifier and displaying the binding device information further includes:
based on the user identifier, initiating a binding device obtaining request;
receiving from the server the binding device information extracted based on the user identifier contained in the binding device obtaining request; and
displaying the received binding device information in an interface of the current device.

3. The method according to claim 1, wherein obtaining a device identifier selected from the displayed binding device information and sending the selected device identifier and resource to be shared to the server further includes:
obtaining a selection instruction triggered by the displayed binding device information;
based on the selection instruction, obtaining the selected device identifier from the binding device information;
extracting the resource to be shared with the device corresponding to the selected device identifier; and
sending the device identifier and the resource to be shared to the server.

4. The method according to claim 3, wherein the resource to be shared is a bookmark, and extracting resource to be shared and sending the device identifier and the resource to be shared to the server further includes:
extracting a webpage address and a title corresponding to the bookmark;
packing the extracted webpage address, the title and the device identifier to obtain a corresponding message; and
sending the obtained message to the server.

5. The method according to claim 1, further including:
receiving, by the corresponding device which is in an active status, the resource delivered by the server according to the device identifier.

6. The method according to claim 1, before extracting corresponding binding device information from a server based on the user identifier and displaying the binding device information, further including:
obtaining the user identifier that logs in the current device and the device identifier corresponding to the device that requests to be bound through a triggered device binding instruction;
based on the device identifier corresponding to the device that requests to be bound, generating the binding device information corresponding to the user identifier that logs in the current device; and
storing the generated binding device information in the server.

7. The method according to claim 1, further including:
obtaining the user identifier that logs in the current device through the resource sharing operation;
based on the user identifier, initiating the binding device obtaining request to a server such that the server extracts the binding device information corresponding to the binding device obtaining request and returns the binding device information to the current device;
receiving and displaying the binding device information by the current device;
obtaining the device identifier selected from the displayed binding device information; and
sending the selected device identifier and the resource to be shared to the server such that the server receives the device identifier and the resource to be shared and delivers the resource to be shared to a corresponding device based on the device identifier.

8. The method according to claim 7, wherein receiving the device identifier and the resource to be shared and delivering the resource to be shared to a corresponding device based on the device identifier further includes:
receiving, by the server, the device identifier and the resource to be shared sent from the current device; and
determining, by the server, whether the device corresponding to the device identifier is in an active status, wherein:
when the device corresponding to the device identifier is in the active status, the server delivers the resource to be shared to the device corresponding to the device identifier; and
when the device corresponding to the device identifier is in an inactive status, the server caches the received device identifier and the resource to be shared.

9. The method according to claim 8, wherein:
receiving the device identifier and the resource to be shared sent from the current device further includes:
receiving the message sent to the server; and
extracting the device identifier from the message; and
delivering the resource to be shared to the device corresponding to the device identifier further includes:
transmitting the message to a message server by the server which receives the message; and
delivering the message to the device corresponding to the device identifier through the message server.

10. The method according to claim 7, before extracting binding device information corresponding to the binding device obtaining request and returning the binding device information to the current device, further including:
obtaining the user identifier that logs in the current device and the device identifier corresponding to the device that requests to be bound through the triggered device binding instruction;
based on the device identifier corresponding to the device that requests to be bound, generating the binding device information corresponding to the user identifier that logs in the current device; and
storing the generated binding device information in the server.

11. A resource sharing system, comprising:
a user identifier obtaining module configured to obtain a user identifier that logs in a current device through a resource sharing operation;
a binding device information extracting module configured to, based on the user identifier, extract corresponding binding device information from a server and display the binding device information; and
a sending processing module configured to obtain a device identifier selected from the displayed binding device information, and send the selected device identifier and resource to be shared with a device corresponding to the selected device identifier to the server; wherein the resource to be shared is delivered to the corresponding device by the server based on the selected device identifier.

12. The system according to claim 11, wherein the binding device information extracting module further includes:
a request initiating unit configured to, based on the user identifier, initiate a binding device obtaining request;
a binding device information receiving unit configured to receive the binding device information extracted based on the user identifier contained in the binding device obtaining request; and
a display unit configured to display the received binding device information in an interface of the current device.

13. The system according to claim 11, wherein the sending processing module further includes:
a device identifier extracting unit configured to obtain a selection instruction triggered by the displayed binding device information, and obtain the selected device identifier from the binding device information based on the selection instruction; and
a sending unit configured to extract the resource to be shared, and send the obtained device identifier and the resource to be shared to the server.

14. The system according to claim 13, wherein when the resource is a bookmark, the sending unit is also configured to:
extract a webpage address and a title corresponding to the bookmark;
pack the extracted webpage address, the title and the device identifier to obtain a corresponding message; and
send the obtained message to the server.

15. The system according to claim 11, further including:
a resource receiving module configured to receive the resource delivered by the server according to the device identifier when the current device is in an active status.

16. The system according to claim 12, further including:
a binding processing module configured to obtain the user identifier that logs in the current device and the device identifier corresponding to the device that requests to be bound through a triggered device binding instruction; and
an information generating module configured to, based on the device identifier corresponding to the device that requests to be bound, generate the binding device information corresponding to the user identifier that logs in the current device, and store the generated binding device information in the server.

17. A resource sharing system, comprising a device and a server which communicates with the device, wherein:
the device further includes:
a request initiating module configured to obtain a user identifier that logs in a current device through a resource sharing operation, and initiate a binding device obtaining request to the server based on the user identifier;
a display module configured to receive and display the returned binding device information; and
a sending processing module configured to obtain the device identifier selected from the displayed binding device information, and send the selected device identifier and the resource to be shared with a device corresponding to the selected device identifier to the server; and
the server further includes:
a request responding module configured to extract the binding device information corresponding to the binding device obtaining request, and return the binding device information to the current device; and
a deliver processing module configured to receive the device identifier and the resource sent from the device, and to deliver the resource to the corresponding device based on the device identifier.

18. The system according to claim 17, wherein the deliver processing module further includes:
a receiving unit configured to receive the device identifier and the resource sent from the current device;
a status determining unit configured to determine whether the device corresponding to the device identifier is in an active status, wherein when the device is in the active status, the status determining unit informs a delivering unit;
the delivering unit configured to deliver the resource to the device corresponding to the device identifier; and
a cache unit configured to, when the device corresponding to the device identifier is in an inactive status, cache the received device identifier and the resource.

19. The system according to claim 18, wherein the receiving unit is further configured to:
receive the message sent to the server; and
extract the device identifier from the message.

20. The system according to claim 18, wherein the delivering unit further includes:
a message transmission unit configured to transmit the message from the server which receives the message to the message server; and
a message deliver unit configured to deliver the message to the device corresponding to the device identifier through the message server.
